(19) United States
(12) Patent Application Publication
(10) Pub. No.: US 2026/0021737 A1
(43) Pub. Date: Jan. 22, 2026

(54) Charging and Discharging Control Method and System for Electric Vehicle Based on Virtual Synchronization

(71) Applicant: ELECTRIC POWER RESEARCH INSTITUTE OF HAINAN POWER GRID CO., LTD., Haikou (CN)

(72) Inventors: Songling PANG, Haikou (CN); Ruien ZHANG, Haikou (CN); Hailong ZHAO, Haikou (CN)

(21) Appl. No.: 19/346,068

(22) Filed: Sep. 30, 2025

Related U.S. Application Data
(63) Continuation of application No. PCT/CN2024/107284, filed on Jul. 24, 2024.

(30) Foreign Application Priority Data
Jun. 27, 2024 (CN) 202410843770.6

(51) Int. Cl. B60L 53/63; B60L 53/16; B60L 53/62; B60L 53/66; B60L 55/00; H02J 3/24; H02J 7/00

(52) U.S. Cl. CPC B60L 53/63; B60L 53/16; B60L 53/62; B60L 53/66; B60L 55/00; H02J 3/241; H02J 7/00032; B60L 2210/10; B60L 2210/30; H02J 2207/20

(57) ABSTRACT

The present invention discloses a charging and discharging control method and system for an electric vehicle based on virtual synchronization, and relates to the technical field of virtual synchronization. The method includes: establishing connection between a power grid and the electric vehicle, and acquiring a charging and discharging operation demand; acquiring, according to the charging and discharging operation demand, a corresponding control instruction and constraint condition, and executing a charging and discharging operation; and providing a human-computer interaction interface for measuring and settling charging and discharging energy, along with authentication. The present invention achieves efficient and coordinated charging and discharging control, precise measurement and convenient authentication, and improves availability and reliability of the system.

### CROSS-REFERENCE TO RELATED APPLICATIONS

This application is a continuation of International Application No. PCT/CN2024/107284, filed on Jul. 24, 2024, and claims priority to Chinese Patent Application No. 202410843770.6, filed on Jun. 27, 2024, the entire disclosure of which is incorporated herein by reference.

### TECHNICAL FIELD

The present invention relates to the technical field of virtual synchronization, and in particular to a charging and discharging control method and system for an electric vehicle based on virtual synchronization.

### BACKGROUND

With the large-scale access of new energy to a power grid, the “double-big” characteristic of a power system are profoundly affecting a morphology and operation characteristics of the power grid. A traditional power grid, dominated by synchronous generators, is changing, characterized by significantly reduced system inertia and damping, which leads to an insufficient dynamic regulation ability of the power grid. Therefore, a stability analysis and control technology for a new energy power system has attracted wide attention. A virtual synchronization machine control strategy enables a device to have the characteristics of a traditional synchronization machine, providing inertia and damping for the power grid to improve frequency stability of the new energy power system. It has important theoretical value and practical significance for constructing a novel power system. Meanwhile, with the rapid penetration of new energy electric vehicles, as of the third quarter of 2023, a number of new energy vehicles in China has reached 18.17 million, including 14.01 million pure electric vehicles, accounting for 76.9% of the total number of new energy vehicles. Occurrence of large-scale and multi-period charging behaviors of the electric vehicles increasingly affects safe operation of the power grid. Therefore, how to ensure rapid and healthy development of the electric vehicle industry while ensuring safe operation of the power grid has become an urgent problem to be solved. Meanwhile, an energy storage battery of the electric vehicle, with its flexible configuration and fast response ability, can provide necessary power support for virtual synchronization machine control participating in power grid regulation. A resulting V2G charging and discharging technology provides possibility to solve this problem. However, an uncontrolled disorderly charging and discharging behavior not only fails to improve an impact on the power grid, but also aggravates its severity. Therefore, the virtual synchronous charging and discharging machine, on the basis of an original V2G charging and discharging technology, is integrated with a virtual synchronous charging and discharging machine technology, leveraging the mobile energy storage characteristic of the electric vehicle to overcome the shortcoming of an excessively fast response speed of a charging/discharging machine. In this way, a dynamic response process of the electric vehicle is closer to a traditional power component, providing frequency and voltage support for the power grid. Applying this technology will be conducive to accelerating integration of vehicles, charging piles and the power grid, and promoting healthy and stable development of related industries.

### SUMMARY

In view of the problems mentioned above, the present invention is proposed.

Therefore, to solve the above technical problems, the present invention provides the following technical solutions: a charging and discharging control method for an electric vehicle based on virtual synchronization includes: establishing connection between a power grid and the electric vehicle, and acquiring a charging and discharging operation demand;
acquiring, according to the charging and discharging operation demand, a corresponding control instruction and constraint condition, and executing a charging and discharging operation; and
providing a human-computer interaction interface for measuring and settling charging and discharging energy, along with authentication.

As a preferred solution of the charging and discharging control method for the electric vehicle based on virtual synchronization of the present invention, in which the establishing connection between a power grid and the electric vehicle includes:
connecting a virtual synchronous charging and discharging apparatus to the power grid via an AC grid-connected interface, and connecting the virtual synchronous charging and discharging apparatus to the electric vehicle via a charging interface; and
establishing a data exchange path via a central control interface and a communication module of the electric vehicle, and acquiring battery state information of the electric vehicle, wherein
the AC grid-connected interface comprises an AC power distribution mechanical switchgear and a leakage protection apparatus.

As a preferred solution of the charging and discharging control method for the electric vehicle based on virtual synchronization of the present invention, in which the acquiring a corresponding control instruction and constraint condition includes:
acquiring a grid-side charging control instruction, discharging control instruction, virtual synchronization control instruction, reactive power compensation control instruction and harmonic compensation control instruction and an electric-vehicle-side constraint condition, wherein
the charging control instruction comprises instantaneous charging start, scheduled charging start, charging pause, charging resume, charging stop and orderly charging control;
the discharging control instruction comprises instantaneous discharging start, scheduled discharging start, discharging pause, discharging resume, discharging stop and orderly discharging control;
the virtual synchronization control instruction comprises virtual synchronization operation mode start, inertia response, primary frequency regulation, reactive power voltage regulation and damping control;
the reactive power compensation control instruction comprises a reactive power compensation mode, reactive power compensation amount setting, reactive power compensation pause, reactive power compensation resume, reactive power compensation stop and automatic reactive power regulation;
the harmonic compensation control instruction comprises harmonic compensation mode start, number of harmonic compensation times setting, harmonic compensation pause, harmonic compensation resume, harmonic compensation stop and automatic harmonic compensation; and
the electric-vehicle-side constraint condition comprises a charging and discharging power demand, a battery capacity, state of charge (SOC) upper and lower limits and an available time;
determining an operational behavior mode according to the acquired control instruction and constraint condition, wherein
the behavior mode comprises a charging mode, a discharging mode, a virtual synchronization mode, a reactive power compensation mode and a harmonic compensation mode; and
dynamically regulating operation states of an active power-frequency module and a reactive power-voltage module, and regulating power and voltage states of a bidirectional AC/DC unit at the same time.

As a preferred solution of the charging and discharging control method for the electric vehicle based on virtual synchronization of the present invention, in which the charging mode includes:
converting electric energy on an AC grid side to DC via a bidirectional AC/DC converter in charging for charging the electric vehicle;
regulating, according to an instruction from the virtual synchronization control unit, a charging power limit and a constant voltage/constant current value, to achieve optimal charging efficiency and power grid load balance;
receiving a charging demand from the electric vehicle and a frequency and voltage regulation demand from the power grid;
calculating, according to the charging demand and a power grid state, a most appropriate charging strategy via a central control unit, wherein
the charging strategy comprises charging time calculation and power regulation; and
executing a charging operation, and monitoring a charging state at the same time.

As a preferred solution of the charging and discharging control method for the electric vehicle based on virtual synchronization of the present invention, in which the discharging mode includes:
converting the DC electric energy of the electric vehicle to AC via the bidirectional AC/DC converter in discharging;
dynamically regulating the discharging power limit and the constant voltage/constant current value as needed by the power grid in real time, and receiving a discharging demand from the electric vehicle and the frequency and voltage regulation demand from the power grid;
controlling DC/DC and AC/DC conversion circuits to start feeding electric energy back to the power grid subsequent to determination of a discharge strategy; and
continuously monitoring the power grid state and a discharge state of a battery of the electric vehicle while meeting the demand of the power grid in discharging.

As a preferred solution of the charging and discharging control method for the electric vehicle based on virtual synchronization of the present invention, in which the virtual synchronization mode includes:
simulating inertia of a synchronous generator and a primary frequency regulation control characteristic of a system;
setting a virtual inertia active power instruction and the primary frequency regulation control characteristic of the system as zero initially;
detecting whether a mechanical angular velocity changes and whether the current mechanical angular velocity deviates from a mechanical angular velocity reference value;
re-calculating and updating, in a case of the mechanical angular velocity changing, the virtual inertia active power instruction Pᵢₙₜ, wherein the formula for calculating Pᵢₙₜ is as follows:

$${P}_{int} = - J ω \frac{d ω}{dt}$$

wherein J is a moment of inertia of a rotor, and ω is the mechanical angular velocity;
keeping, in a case of no change on the mechanical angular velocity, the virtual inertia active power instruction Pᵢₙₜ unchanged;
re-calculating and updating, in a case of the current mechanical angular velocity deviating from the mechanical angular velocity reference value, the primary frequency regulation control characteristic P_{droop}, wherein the formula for calculating P_{droop} is as follows:

$${P}_{droop} = - \frac{1}{m} ( ω - {ω}_{ref} )$$

wherein ω_{ref} is the mechanical angular velocity reference value, and m is a droop coefficient;
outputting and issuing, by a virtual governor, an active power instruction P_{ref} to the active power-frequency module, wherein the formula for calculating P_{ref} is as follows:

$${P}_{ref} = {P}_{int} + {P}_{droop}$$

issuing the active power instruction P_{ref} to the active power-frequency module, and regulating a grid-connected current by means of current closed-loop feedback control;
controlling, by a virtual exciter, a reactive power voltage characteristic of the synchronous generator, wherein an output reactive power instruction Q_{ref} of a virtual synchronous charging and discharging machine is:

$${Q}_{ref} = {K}_{V} {S}_{N} ( U - {U}_{ref} ) / {U}_{N}$$

wherein K_{V} is a reactive power voltage regulation coefficient, S_{N} is a rated apparent power, U is a grid-side voltage, U_{ref} is a reference voltage, and U_{N} is a rated voltage;
detecting whether there are external factors, wherein
external influence detection comprises load sudden change detection and power grid frequency deviation detection, and
load sudden change detection comprises:
periodically acquiring a sampled load power value P_{load}(k), and calculating a load power change amount ΔP_{load}(k), wherein the formula for calculating ΔP_{load}(k) is as follows:

$$Δ {P}_{load} ( k ) = Δ {P}_{load} ( k - 1 ) + {dP}_{load} ( k ) / dt * T$$

wherein k is a sampling sequence number, and T is a sampling period;
considering occurrence of a load sudden change in a case of the load power change amount ∥ |ΔP_{load}(k)| being larger than a load sudden change criterion threshold P_{Id};
monitoring a power grid frequency f_{grid} in real time, and calculating a frequency deviation Δf_{grid}, wherein the formula for calculating Δf_{grid} is as follows:

$$Δ {f}_{grid} = {f}_{grid} - {f}_{ref}$$

wherein f_{ref} is a power grid rated frequency reference value;
considering there is the power grid frequency deviation in a case of |Δf_{grid}| being larger than a frequency deviation criterion threshold f_{gd};
compensating, if so, the active power instruction P_{ref} correspondingly, and keeping the grid-connected current at a preset value, wherein
compensation components comprise a load sudden change compensation component and a power grid frequency deviation compensation component;
the formula for calculating the load sudden change compensation component ΔP_{load_comp} is as follows:

$$Δ {P}_{load \_ comp} = - Δ {P}_{load} ( k )$$

and the formula for calculating the power grid frequency deviation compensation component ΔP_{fgrid_comp} is as follows:

$$Δ {P}_{fgrid \_ comp} = {k}_{f} * Δ {f}_{grid}$$

wherein k_{f} is a frequency-active power control coefficient;
re-calculating the active power instruction according to the compensation components, and acquiring a final active power instruction P_{ref_new}, wherein the calculation formula is as follows:

$${P}_{ref \_ new} = {P}_{ref} + Δ {P}_{fgrid \_ comp} + Δ {P}_{load \_ comp}$$

issuing, by a coordinated control module, an operation parameter by using parallel bus communication, and dynamically regulating operation states of the active power-frequency module and the reactive power-voltage module; and
regulating a reactive power of the bidirectional AC/DC unit and charging and discharging power limits of the DC/DC module, allowing for a function of the virtual synchronous charging and discharging machine participating in frequency and voltage regulation functions of the power grid.

As a preferred solution of the charging and discharging control method for the electric vehicle based on virtual synchronization of the present invention, in which the measuring and settling includes:
accurately measuring an energy flow in charging and discharging via a bidirectional measuring unit, and providing a user with precise billing and settlement information; and
the authentication comprises:
performing, by the user, charging authentication via card swipe, two-dimensional code scanning, or password input, and viewing relevant data in charging and discharging, wherein
the relevant data comprises the energy flow, a power level and a charging duration.

Another objective of the present invention is to provide a charging and discharging control system for an electric vehicle based on virtual synchronization. To solve the above technical problems, the present invention provides the following technical solutions: the charging and discharging control system for the electric vehicle based on virtual synchronization includes an AC grid-connected interface unit, a bidirectional AC/DC unit, a bidirectional DC/DC unit, a switch control unit, a bidirectional measuring unit, a central control unit, a charging interface unit and a virtual synchronization control unit, where
the AC grid-connected interface unit is configured to connect a virtual synchronous charging and discharging machine with a power grid in starting, and disconnect the virtual synchronous charging and discharging machine with the power grid in a case of a fault;
the bidirectional AC/DC unit is configured to convert filtered electric energy on an AC grid side to DC, and convert the DC electric energy from the electric vehicle to AC for being fed back to the power grid, and is connected to the virtual synchronization control unit for regulating an active/reactive power operation state according to an instruction from the central control unit;
the bidirectional DC/DC unit is configured to achieve power conversion with a DC port on the electric vehicle side;
the switch control unit is configured to control a DC connection state with the battery of the electric vehicle;
the bidirectional measuring unit is configured to provide a human-computer interaction interface and record various data in charging and discharging;
the central control unit is configured to process frequency and voltage regulation instructions from the power grid, receive the battery state information of the vehicle, and coordinate operations of various units to overall control virtual synchronous charging and discharging;
the charging interface unit is configured to connect the virtual synchronous charging and discharging machine with the electric vehicle in charging and discharging; and
the virtual synchronization control unit is configured to dynamically regulate charging operation parameters according to a higher-level instruction, simulate electromechanical transient characteristics, construct virtual inertia and primary frequency regulation power instructions, and regulate a grid-connected current by means of a current closed loop.

A computer device includes a memory in which a computer program is stored and a processor, where the processor, when executing the computer program, implements the steps of the above charging and discharging control method for the electric vehicle based on virtual synchronization are implemented.

A computer-readable storage medium in which a computer program is stored, where when the computer program is executed by a processor, the steps of the above charging and discharging control method for the electric vehicle based on virtual synchronization are implemented.

The present invention has the beneficial effects that the virtual synchronous charging and discharging machine designed in this solution enables continuous and smooth active power regulation and has the functions of an inertia response, damping control, etc. It is conductive to overcoming the defect of an excessively fast response speed of a charging/discharging machine for a battery of the electric vehicle, making a dynamic response process of an energy storage battery of the electric vehicle closer to a traditional power component. It provides frequency and voltage support for the power grid and regulates an active/reactive power of the system to provide frequency regulation and voltage regulation for the power grid. Applying this technology will be conducive to accelerating integration of vehicles, charging piles and the power grid, and promoting healthy and stable development of related industries.

### BRIEF DESCRIPTION OF DRAWINGS

To more clearly describe the technical solutions of the embodiments of the present invention, the accompanying drawings required to describe the embodiments are briefly described below. Apparently, the accompanying drawings described below are only some embodiments of the present invention. Those skilled in the art can also obtain other drawings based on these accompanying drawings without inventive effort.

FIG. 1 is a schematic structural diagram of a terminal according to a first embodiment of the present invention;

FIG. 2 is a schematic flowchart according to a first embodiment of the present invention;

FIG. 3 is a schematic structural diagram of a computer device according to a third embodiment of the present invention;

FIG. 4 is a diagram of system modules according to a second embodiment of the present invention; and

FIG. 5 is a flowchart topology diagram of a virtual control flow according to a fourth embodiment of the present invention.

### DETAILED DESCRIPTION OF THE EMBODIMENTS

In order to make the aforementioned purposes, features and advantages of the present invention more apparent and comprehensible, detailed descriptions of specific implementations of the present invention are provided below in conjunction with the appended drawings. Apparently, the described embodiments are merely a part of the embodiments of the present invention, rather than all embodiments. On the basis of the examples of the present invention, all other examples obtained by those of ordinary skill in the art without creative efforts shall fall within the protection scope of the present invention.

A number of specific details are set forth in the description below to provide a thorough understanding for the present invention, however, the present invention may also be implemented in other manners different from those described herein, and those skilled in the art may make similar generalization without departing from the essence of the present invention; and therefore, the present invention is not limited by the specific embodiments disclosed below.

### Embodiment 1

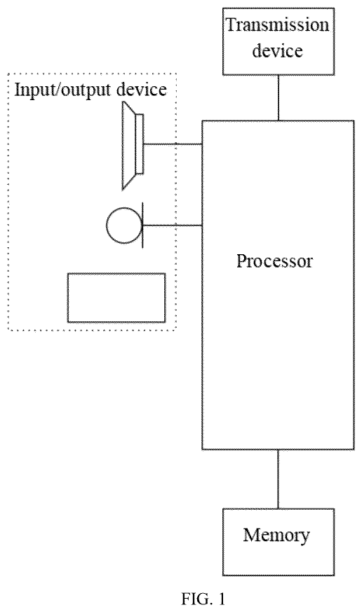

Referring to FIGS. 1-5, showing an embodiment of the present invention, it provides a charging and discharging control method for an electric vehicle based on virtual synchronization.

First, the charging and discharging control method for the electric vehicle based on virtual synchronization provided by the present application can be applied to a terminal shown in FIG. 1. As shown in FIG. 1, the terminal may include one or two processors (only one shown in FIG. 1) and a memory for storing data, where the processor may include, but is not limited to, a processing system such as a microprocessor MCU or a programmable logic device FPGA. The above terminal may further include a transmission device and an input/output device for communication functions. It should be understood by those of ordinary skill in the art that the structure shown in FIG. 1 is only illustrative and does not limit the structure of the above terminal. For example, the terminal may further include more or fewer components than that shown in FIG. 1, or have a configuration different from that shown in FIG. 1.

The memory may be used for storing a computer program such as a computer program corresponding to the charging and discharging control method for the electric vehicle based on virtual synchronization in this embodiment, and the processor executes various functional applications and data processing by executing the computer program stored in the memory, that is, to implement the above-described method. The memory may include a high-speed random memory, and may further include a nonvolatile memory such as one or more magnetic storage systems, a flash memory, or another nonvolatile solid-state memory. In some examples, the memory may further includes memories configured remotely relative to the processor, and these remote memories may be connected to the computer device via a network. Examples of such networks may include, but are not limited to, Internet, intranet, a local area network, a mobile communication network, and combinations thereof.

The transmission device is configured to receive or send data via a network. The aforementioned network includes a wireless network provided by a terminal's communication service provider. In an example, the transmission device includes a network interface controller (NIC), and the NIC may be connected to another network device or a router by using a base station, so as to communicate with the Internet. In an example, the transmission device may be a Radio Frequency (RF) module configured to communicate with the Internet wirelessly.

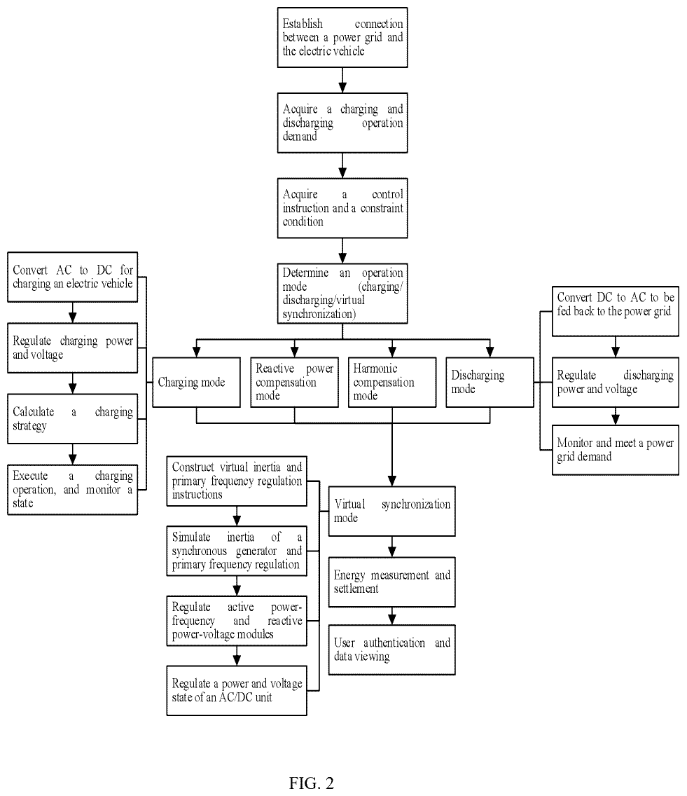

as shown in FIG. 2, an embodiment of the present invention provides a charging and discharging control method for an electric vehicle based on virtual synchronization. This embodiment is described by using an example in which the method is applied to the terminal in FIG. 1, and the method includes the following steps:
S1: Establishing connection between a power grid and the electric vehicle, and acquiring a charging and discharging operation demand, specifically:
S1.1: connecting a virtual synchronous charging and discharging apparatus to the power grid via an AC grid-connected interface, and connecting the virtual synchronous charging and discharging apparatus to the electric vehicle via a charging interface, where
the AC grid-connected interface includes an AC power distribution mechanical switchgear and leakage protection apparatus; and
the AC grid-connected interface has the functions of turnon/turnoff of an AC and leakage protection;
an AC/DC unit is configured to stabilize a bus voltage and control a reactive power;
a DC/DC unit is configured to perform bidirectional constant-voltage and constant-current control, and control an active power in charging and discharging;
the AC/DC unit issues an active power control upper limit value to the DC/DC unit via communication;
the active power control upper limit value is determined by taking the minimum value among: an orderly charging power limit value, a BCL required power and an active power value given by primary frequency regulation, inertia response and damping control; and
this embodiment is different from an existing patent in that the AC/DC unit is only responsible for reactive power and harmonic control, and the DC/DC unit is only responsible for active power control; and active power control and reactive power control are completely decoupled, so that charging and discharging share a set of hardware circuits and a set of control algorithms; and
S1.2: establishing a data exchange path via a central control interface and a communication module of the electric vehicle, and acquiring battery state information of the electric vehicle.

S2: Acquiring, according to the charging and discharging operation demand, a corresponding control instruction and constraint condition, and executing a charging and discharging operation, specifically:

S2.1: the acquiring a corresponding control instruction and constraint condition includes:
acquiring a grid-side charging control instruction, discharging control instruction, virtual synchronization control instruction, reactive power compensation control instruction and harmonic compensation control instruction and an electric-vehicle-side constraint condition, wherein
the charging control instruction includes instantaneous charging start, scheduled charging start, charging pause, charging resume, charging stop and orderly charging control;
the discharging control instruction includes instantaneous discharging start, scheduled discharging start, discharging pause, discharging resume, discharging stop and orderly discharging control;
the virtual synchronization control instruction includes virtual synchronization operation mode start, inertia response, primary frequency regulation, reactive power voltage regulation and damping control;
the reactive power compensation control instruction includes a reactive power compensation mode, reactive power compensation amount setting, reactive power compensation pause, reactive power compensation resume, reactive power compensation stop and automatic reactive power regulation;
the harmonic compensation control instruction includes harmonic compensation mode start, number of harmonic compensation times setting, harmonic compensation pause, harmonic compensation resume, harmonic compensation stop and automatic harmonic compensation; and
this embodiment is different from an existing patent in that the system can receive an orderly charging instruction and work in a virtual synchronization mode, and can perform reactive power compensation and harmonic compensation automatically at the same time to maximize the role of a virtual synchronous charging and discharging machine.

The electric-vehicle-side constraint condition includes a charging and discharging power demand, a battery capacity, state of charge (SOC) upper and lower limits and an available time;
determining an operational behavior mode according to the acquired control instruction and constraint condition, wherein
the behavior mode includes a charging mode, a discharging mode, a virtual synchronization mode, a reactive power compensation mode and a harmonic compensation mode; and
dynamically regulating operation states of an active power-frequency module and a reactive power-voltage module, and regulating power and voltage states of a bidirectional AC/DC unit;

S2.2: the charging mode includes:
converting electric energy on an AC grid side to DC via a bidirectional AC/DC converter in charging for charging the electric vehicle;
regulating, according to an instruction from the virtual synchronization control unit, a charging power limit and a constant voltage/constant current value, to achieve optimal charging efficiency and power grid load balance;
receiving a charging demand from the electric vehicle and a frequency and voltage regulation demand from the power grid;
calculating, according to the charging demand and a power grid state, a most appropriate charging strategy via a central control unit, wherein
the charging strategy includes charging time calculation, power regulation, etc.; and
executing a charging operation, and monitoring a charging state at the same time to ensure safe and efficient charging;

S2.3: the discharging mode includes:
converting the DC electric energy of the electric vehicle to AC via the bidirectional AC/DC converter in discharging;
dynamically regulating the discharging power limit and the constant voltage/constant current value as needed by the power grid in real time, and receiving a discharging demand from the electric vehicle and the frequency and voltage regulation demand from the power grid;
controlling DC/DC and AC/DC conversion circuits to start feeding electric energy back to the power grid subsequent to determination of a discharge strategy; and
continuously monitoring the power grid state and a discharge state of a battery of the electric vehicle while meeting the demand of the power grid in discharging.

S2.4: the virtual synchronization mode includes:
simulating inertia of a synchronous generator and a primary frequency regulation control characteristic of a system;
setting a virtual inertia active power instruction and the primary frequency regulation control characteristic of the system as zero initially;
detecting whether a mechanical angular velocity changes and whether the current mechanical angular velocity deviates from a mechanical angular velocity reference value;
re-calculating and updating, in a case of the mechanical angular velocity changing, the virtual inertia active power instruction Pᵢₙₜ, wherein the formula for calculating Pᵢₙₜ is as follows:

$${P}_{int} = - J ω \frac{d ω}{dt}$$

wherein J is a moment of inertia of a rotor, and ω is the mechanical angular velocity;
keeping, in a case of no change on the mechanical angular velocity, the virtual inertia active power instruction Pᵢₙₜ unchanged;
re-calculating and updating, in a case of the current mechanical angular velocity deviating from the mechanical angular velocity reference value, the primary frequency regulation control characteristic P_{droop}, wherein the formula for calculating P_{droop} is as follows:

$${P}_{droop} = - \frac{1}{m} ( ω - {ω}_{ref} )$$

wherein ω_{ref} is the mechanical angular velocity reference value, and m is a droop coefficient;
outputting and issuing, by a virtual governor, an active power instruction P_{ref} to the active power-frequency module, where the formula for calculating P_{ref} is as follows:

$${P}_{ref} = {P}_{int} + {P}_{droop}$$

controlling, by a virtual excitation controller, a reactive power voltage characteristic of the synchronous generator, where an output reactive power instruction Q_{ref} of the virtual synchronous charging and discharging machine is:

$${Q}_{ref} = {K}_{V} {S}_{N} ( U - {U}_{ref} ) / {U}_{N}$$

wherein K_{V} is a reactive power voltage regulation coefficient, S_{N} is a rated apparent power, U is a grid-side voltage, U_{ref} is a reference voltage, and U_{N} is a rated voltage;
detecting whether there are external factors, wherein
external influence detection comprises load sudden change detection and power grid frequency deviation detection, and
load sudden change detection comprises:
periodically acquiring a sampled load power value P_{load}(k), and calculating a load power change amount ΔP_{load}(k), wherein the formula for calculating ΔP_{load}(k) is as follows:

$$Δ {P}_{load} ( k ) = Δ {P}_{load} ( k - 1 ) + {dP}_{load} ( k ) / dt * T$$

wherein k is a sampling sequence number, and T is a sampling period;
considering occurrence of a load sudden change in a case of the load power change amount ∥ |ΔP_{load}(k)| being larger than a load sudden change criterion threshold P_{Id};
monitoring a power grid frequency f_{grid} in real time, and calculating a frequency deviation Δf_{grid}, wherein the formula for calculating Δf_{grid} is as follows:

$$Δ {f}_{grid} = {f}_{grid} - {f}_{ref}$$

wherein f_{ref} is a power grid rated frequency reference value;
considering there is the power grid frequency deviation in a case of |Δf_{grid}| being larger than a frequency deviation criterion threshold f_{gd};
compensating, if so, the active power instruction P_{ref} correspondingly, and keeping the grid-connected current at a preset value, wherein
compensation components comprise a load sudden change compensation component and a power grid frequency deviation compensation component;
the formula for calculating the load sudden change compensation component ΔP_{load_comp} is as follows:

$$Δ {P}_{load \_ comp} = - Δ {P}_{load} ( k )$$

and the formula for calculating the power grid frequency deviation compensation component ΔP_{fgrid_comp} is as follows:

$$Δ {P}_{fgrid \_ comp} = {k}_{f} * Δ {f}_{grid}$$

wherein k_{f} is a frequency-active power control coefficient;
re-calculating the active power instruction according to the compensation components, re new and acquiring a final active power instruction P_{ref_new}, wherein the calculation formula is as follows:

$${P}_{ref \_ new} = {P}_{ref} + Δ {P}_{fgrid \_ comp} + Δ {P}_{load \_ comp}$$

issuing, by a coordinated control module, an operation parameter by using parallel bus communication, and dynamically regulating operation states of the active power-frequency module and the reactive power-voltage module; and
regulating a reactive power of the bidirectional AC/DC unit and charging and discharging power limits of the DC/DC module, allowing for a function of the virtual synchronous charging and discharging machine participating in frequency and voltage regulation functions of the power grid.

S3: Providing a human-computer interaction interface for measuring and settling charging and discharging energy, along with authentication, specifically:
S3.1: accurately measuring an energy flow in charging and discharging via a bidirectional measuring unit, and providing a user with precise billing and settlement information; and
S3.2: performing, by the user, charging authentication via card swipe, two-dimensional code scanning, or password input, and viewing relevant data in charging and discharging, where

the relevant data comprises the energy flow, a power level and a charging duration.

### Embodiment 2

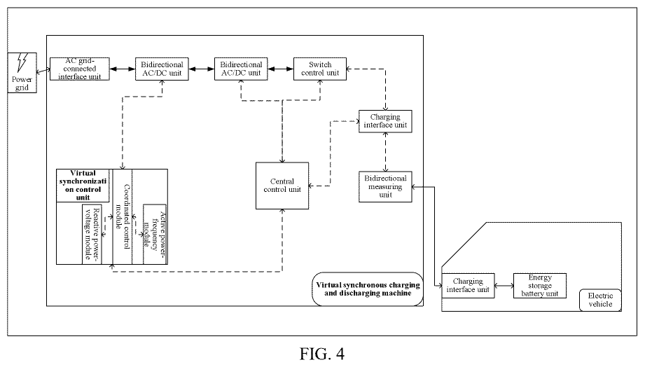

Referring to FIG. 4, showing an embodiment of the present invention, it provides a charging and discharging control system for an electric vehicle based on virtual synchronization, including: an AC grid-connected interface unit, a bidirectional AC/DC unit, a bidirectional DC/DC unit, a switch control unit, a bidirectional measuring unit, a central control unit, a charging interface unit virtual synchronization control unit.

The AC grid-connected interface unit includes an AC power distribution mechanical switch and a leakage protection apparatus, and is configured to connect a virtual synchronous charging and discharging machine with a power grid in starting, and disconnecting the virtual synchronous charging and discharging machine with the power grid in a case of a fault.

The bidirectional AC/DC unit includes an bidirectional AC/DC converter and an auxiliary cooling system, is configured to convert filtered electric energy on an AC grid side to DC, and convert the DC electric energy from the electric vehicle to AC for being fed back to the power grid, and is connected to the virtual synchronization control unit for regulating an active/reactive power operation state according to an instruction from the central control unit.

The bidirectional DC/DC unit includes a DC/DC bidirectional converter and an auxiliary cooling system, and is configured to achieve power conversion with a DC port on the electric vehicle side.

The switch control unit includes a DC mechanical switchgear, and is configured to control a DC connection state with the battery of the electric vehicle.

The bidirectional measuring unit includes a module integrating functions of measurement, authentication, settlement and human-machine interaction, and is configured to provide a human-computer interaction interface and record various data in charging and discharging.

The central control unit includes a charging connection control and guidance module, a DC acquisition and control module and a battery management system communication module, and is configured to process frequency and voltage regulation instructions from the power grid, receive the battery state information of the vehicle, and coordinate operations of various units to overall control virtual synchronous charging and discharging.

The charging interface unit includes a vehicle connector and a charging cable, and is configured to connect the virtual synchronous charging and discharging machine with the electric vehicle in charging and discharging.

The virtual synchronization control unit includes an active power-frequency module, a coordinated control module, a reactive power-voltage module, and is configured to dynamically regulate charging operation parameters according to a higher-level instruction, simulate electromechanical transient characteristics such as inertia and damping of the synchronization machine, construct virtual inertia and primary frequency regulation power instructions, regulate a grid-connected current by means of a current closed loop, and then simulate inertia of the synchronous generator and primary frequency regulation control of the system.

For a specific limitation of the charging and discharging control system for the electric vehicle based on virtual synchronization, reference may be made to the foregoing limitation on the charging and discharging control method for the electric vehicle based on virtual synchronization, and details are not repeatedly described herein. Each module in the forgoing charging and discharging control system for the electric vehicle based on virtual synchronization can be implemented in whole or in part by software, hardware, and combinations thereof. Each of the above modules may be embedded in or independent of a processor in a computer device in a hardware form, or may be stored in a memory in the computer device in a software form, so that the processor calls operations corresponding to the above modules.

### Embodiment 3

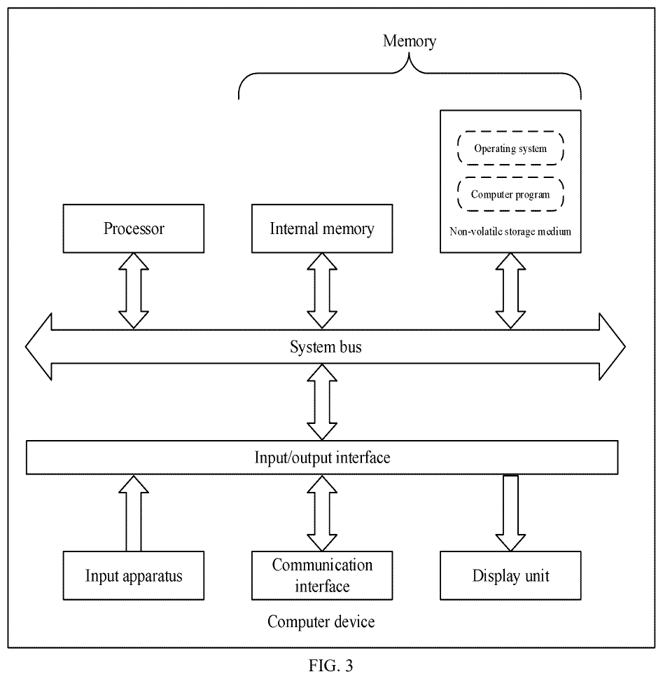

Referring to FIG. 3, showing a third embodiment of the present invention. On the basis of the previous two embodiments, this embodiment of the present invention provides a computer device, which may be a server, and its internal structural diagram may be shown in FIG. 3. The computer device includes a processor, a memory, and a network interface, which are connected by means of a system bus. The processor of the computer device is used for providing calculation and control capabilities. The memory of the computer device includes a non-volatile storage medium and an internal memory. This non-volatile storage medium stores an operating system, a computer program, and a database. The internal memory provides an environment for running of the operating system and the computer program in the non-volatile storage medium.

The database of the computer device is configured to store action detection data. The network interface of the computer device is used to communicate with an external terminal via a network. The computer program, when executed by the processor, implements the steps of any one of the above method embodiments for accelerating sparse tensor operations.

Those skilled in the art may appreciate that the structure shown in FIG. 3 is only a block diagram of a part of the structures related to the solution of the present application, but is not intended to limit the computer device to which the solution of the present application is applied, and the specific computer device may include more or fewer components than shown in the drawing, or combine certain components, or have a different arrangement of components.

In an embodiment, the embodiment of the present invention provides a computer-readable storage medium, with a computer program stored thereon. The computer program, when executed by the processor, implements the steps of any one of the above method embodiments for accelerating sparse tensor operations.

Those of ordinary skill in the art may appreciate that all or a part of flows in the embodiment methods described above may be accomplished by instructing relevant hardware through a computer program. The computer program may be stored in one non-volatile computer-readable storage medium. When being executed, the computer program may include the flows of the embodiments of the foregoing methods. Any reference to the memory, a database or other media used in the embodiments provided by the present application may include at least one of a non-volatile memory and a volatile memory. The non-volatile memory may include a read-only memory (ROM), a magnetic tape, a floppy disk, a flash memory, or an optical memory. The volatile memory may include a random access memory (RAM) or an external cache memory. By way of illustration and not limitation, the RAM may be in various forms, such as static random access memory (SRAM) or dynamic random access memory (DRAM).

### Embodiment 4

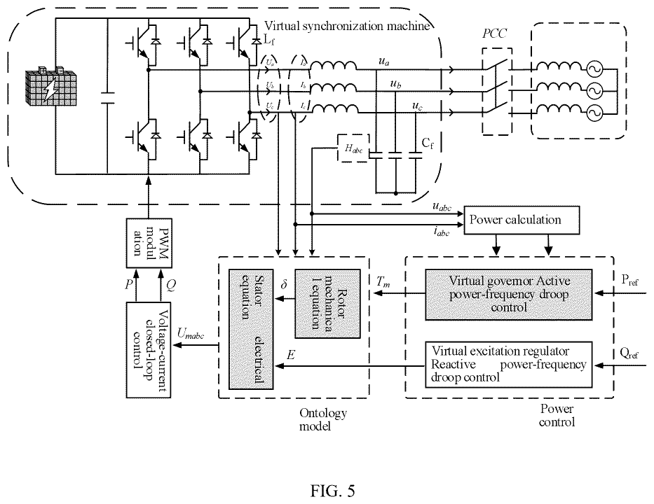

Referring to FIG. 5, showing an embodiment of the present invention, it provides a charging and discharging control method for an electric vehicle based on virtual synchronization. In order to verify the beneficial effects of the present invention, scientific demonstration is performed through economic benefit calculation and a simulation experiment.

### Experimental Preparation and Detailed Process

In order to verify effectiveness and advantages of the mentioned charging and discharging control method for an electric vehicle based on virtual synchronization, the following experiment is conducted.

An experimental platform includes: an AC power simulator (for simulating a power grid), a battery simulator (for simulating a battery of the electric vehicle) and a set of virtual synchronous charging and discharging control system. A virtual synchronization control system mainly includes an AC grid-connected interface, a bidirectional AC/DC converter, a bidirectional DC/DC converter, a switch module, a measuring module, a central controller, a charging interface and a virtual synchronization control module.

There are three scenarios for the experiment: a charging mode, a discharging mode and a virtual synchronization mode. The method is compared with the prior art in each mode.

### Charging Mode Experiment

First, an AC power simulator is connected to an AC grid-connected interface of a virtual synchronization system, and a charging interface is connected to a battery simulator. It is set in the central controller that: a charging demand is 20 kW, and an initial SOC of a battery is 30%.

A traditional charging mode is to directly convert AC to DC via AC/DC and DC/DC converters to provide constant-current/constant-voltage charging, without regulation based on a power grid load state. By contrast, the method of the present invention dynamically regulates a charging power and voltage under the guidance of a virtual synchronization control module, achieving optimal charging efficiency and peak cutting/valley filling.

A specific method is as follows: first, a reasonable charging power curve is calculated according to a current load state of the power grid, for example, an increased power in a valley section and a proper reduced power in a peak section; and next, operating points of the AC/DC and DC/DC converters are dynamically regulated to output corresponding power and voltage values. Meanwhile, a change on an SOC of the battery is monitored, and charging automatically stops in a case of a sufficient capacity.

### Discharging Mode Experiment

The battery simulator is set with SOC being 70%, and is connected to the virtual synchronization system. A simulation power grid issues a 10 kW reactive power regulation instruction, requiring execution within 5 min.

A traditional approach involves direct battery discharging at a fixed power output, which fails to meet a flexible regulation demand of the power grid. By contrast, the present invention dynamically regulates the discharge power continuously within a range from 1 kW to 20 kW in response to a real-time power grid demand.

Specific implementation is to issue the power grid instruction to the virtual synchronization module via the central controller for coordinating operation states of the DC/DC and AC/DC converters, outputting the required reactive power, and monitoring a qualified grid voltage in real time at the same time.

### Virtual Synchronization Mode Experiment

The simulation power grid issues frequency and voltage regulation instructions, requiring completion within 5 s. Meanwhile, the battery is set with the SOC being 60%, and its available time lasts for 3 h. The above information is transferred to the central controller.

In the prior art, due to lack of inertia and damping links, it is unable to smoothly regulate the active and reactive powers like a synchronous generator, and can only perform sharp regulation, resulting in a power grid oscillation.

In various modes, data is automatically recorded via the bidirectional measuring module, and is displayed on the human-computer interaction interface for user viewing and settlement. A manual authentication link is implemented via card swipe, a two-dimensional code, or a password.

Based on the above experimental operations, the following experimental comparative data table is provided:

TABLE 1
Experimental Comparison Table

| | | Charging | | Discharging | Virtual |
|---|---|---|---|---|---|
| | Charging | mode (the | Discharging | mode (the | synchronization |
| | mode | present | mode | present | mode (the present |
| Test object | (traditional) | invention) | (traditional) | invention) | invention) |
| Peak power | 20 | 15 | 10 | 8-18 | 8~18 |
| (kW) | | | | | |
| Peak time | Full | 8 | Full | 5 | Transition |
| (min) | process | | process | | for 5 s |
| Efficiency | 0.92 | 0.95 | 0.93 | 0.96 | 0.95 |
| Loss of power | 1.2 | 0.6 | — | — | — |
| grid in valley | | | | | |
| section (kWh) | | | | | |
| Loss of power | 1.8 | 1.2 | — | — | — |
| grid in peak | | | | | |
| section (kWh) | | | | | |
| Response time | — | — | — | <0.2 | <0.1 |
| (s) | | | | | |
| Voltage | — | — | — | <±3% | <±1% |
| deviation | | | | | |

It can be seed from the table that the method of the present invention demonstrates significant advantages and innovation in all the three modes: the charging mode, the discharging mode and the virtual synchronization mode.

In the charging mode, the conventional method keeps the power at a constant peak of 20 kW, resulting in a loss of 3 kWh of the power grid within 2 h. By contrast, the method of the present invention, by employing a peak cutting and valley filling strategy, controls the peak power at 15 kW (with a duration of only 8 min). This results in a loss of 1.2 kWh of the power grid in the peak section and further reduction in loss to 0.6 kWh in the valley section, achieving an overall reduction of 50% or above. In another aspect, dynamically optimizing the charging curve enables charging efficiency of the method to achieve 0.95, which representing a 3-percentage-point increase over the conventional method.

The discharging mode is a critical function for supporting power grid regulation. The conventional method employs discharging at a fixed power of 10 kW, which not only fails to meet the dynamic regulation demand of the power grid, but also represents an inefficient power transmission mode. By contrast, the method of the present invention, under collaboration of central control and virtual synchronization control, enables continuous discharging power regulation within a range from 1 kW to 20 kW, with a response time smaller than 0.2 s, thereby meeting a real-time requirement for power grid regulation. The discharging efficiency is also improved from 0.93 to 0.96.

The virtual synchronization mode is the most innovative. The prior art cannot simulate the inertia and damping characteristics of the synchronous generator, and can only forcibly change power output, leading to a power grid oscillation. The method of the present invention allows the virtual synchronous charging and discharging machine to smoothly regulate the active power like the synchronous generator via a Pref control algorithm, along with precise control on voltage, thereby ensuring stable operation of the power grid. It can be seen from data that the method achieves extremely rapid response for only 0.1 s, and keeps a voltage deviation within ±1%.

In summary, it can be clear from comparative experimental data that the present invention exhibits unique innovative points and outstanding performance across all the three operation modes, fully verifying the effectiveness and the advantages of the method. Therefore, it provides an important technical solution for promoting efficient collaborative operation of the electric vehicle and the power grid.

It should be noted that, the above embodiments are merely used for illustrating the technical solutions of the present invention and not to limit the technical solutions. Although the present invention has been described in detail with reference to the preferred embodiments, those of ordinary skill in the art should understand that, modifications or equivalent substitutions may be made on the technical solution of the present invention without departing from the spirit and scope of the technical solutions of the present invention, and should be incorporated into the scope of the claims of the present invention.

What is claimed is:

1. A charging and discharging control method for an electric vehicle based on virtual synchronization, comprising:
establishing connection between a power grid and the electric vehicle, and acquiring a charging and discharging operation demand;
acquiring, according to the charging and discharging operation demand, a corresponding control instruction and constraint condition, and executing a charging and discharging operation; and
providing a human-computer interaction interface for measuring and settling charging and discharging energy, along with authentication.

2. The charging and discharging control method for the electric vehicle based on virtual synchronization according to claim 1, wherein the establishing connection between a power grid and the electric vehicle comprises:
connecting a virtual synchronous charging and discharging apparatus to the power grid via an AC grid-connected interface, and connecting the virtual synchronous charging and discharging apparatus to the electric vehicle via a charging interface; and
establishing a data exchange path via a central control interface and a communication module of the electric vehicle, and acquiring battery state information of the electric vehicle, wherein
the AC grid-connected interface comprises an AC power distribution mechanical switchgear and a leakage protection apparatus.

3. The charging and discharging control method for the electric vehicle based on virtual synchronization according to claim 2, wherein the acquiring a corresponding control instruction and constraint condition comprises:
acquiring a grid-side charging control instruction, discharging control instruction, virtual synchronization control instruction, reactive power compensation control instruction and harmonic compensation control instruction and an electric-vehicle-side constraint condition, wherein
the charging control instruction comprises instantaneous charging start, scheduled charging start, charging pause, charging resume, charging stop and orderly charging control;
the discharging control instruction comprises instantaneous discharging start, scheduled discharging start, discharging pause, discharging resume, discharging stop and orderly discharging control;
the virtual synchronization control instruction comprises virtual synchronization operation mode start, inertia response, primary frequency regulation, reactive power voltage regulation and damping control;
the reactive power compensation control instruction comprises a reactive power compensation mode starting, reactive power compensation amount setting, reactive power compensation pause, reactive power compensation resume, reactive power compensation stop and automatic reactive power regulation;
the harmonic compensation control instruction comprises harmonic compensation mode start, number of harmonic compensation times setting, harmonic compensation pause, harmonic compensation resume, harmonic compensation stop and automatic harmonic compensation; and
the electric-vehicle-side constraint condition comprises a charging and discharging power demand, a battery capacity, state of charge (SOC) upper and lower limits and an available time;
determining an operational behavior mode according to the acquired control instruction and constraint condition, wherein
the behavior mode comprises a charging mode, a discharging mode, a virtual synchronization mode, a reactive power compensation mode and a harmonic compensation mode; and
dynamically regulating operation states of an active power-frequency module and a reactive power-voltage module, and regulating power and voltage states of a bidirectional AC/DC unit at the same time.

4. The charging and discharging control method for the electric vehicle based on virtual synchronization according to claim 3, wherein the charging mode comprises:
converting electric energy on an AC grid side to DC via a bidirectional AC/DC converter in charging for charging the electric vehicle;
regulating, according to an instruction from the virtual synchronization control unit, a charging power limit and a constant voltage/constant current value, to achieve optimal charging efficiency and power grid load balance;
receiving a charging demand from the electric vehicle and a frequency and voltage regulation demand from the power grid;
calculating, according to the charging demand and a power grid state, a most appropriate charging strategy via a central control unit, wherein
the charging strategy comprises charging time calculation and power regulation; and
executing a charging operation, and monitoring a charging state at the same time.

5. The charging and discharging control method for the electric vehicle based on virtual synchronization according to claim 4, wherein the discharging mode comprises:
converting the DC electric energy of the electric vehicle to AC via the bidirectional AC/DC converter in discharging;
dynamically regulating the discharging power limit and the constant voltage/constant current value as needed by the power grid in real time, and receiving a discharging demand from the electric vehicle and the frequency and voltage regulation demand from the power grid;
controlling DC/DC and AC/DC conversion circuits to start feeding electric energy back to the power grid subsequent to determination of a discharge strategy; and
continuously monitoring the power grid state and a discharge state of a battery of the electric vehicle while meeting the demand of the power grid in discharging.

6. The charging and discharging control method for the electric vehicle based on virtual synchronization according to claim 5, wherein the virtual synchronization mode comprises:
simulating inertia of a synchronous generator and a primary frequency regulation control characteristic of a system;
setting a virtual inertia active power instruction and the primary frequency regulation control characteristic of the system as zero initially;
detecting whether a mechanical angular velocity changes and whether the current mechanical angular velocity deviates from a mechanical angular velocity reference value;
re-calculating and updating, in a case of the mechanical angular velocity changing, the virtual inertia active power instruction Pᵢₙₜ, wherein the formula for calculating Pᵢₙₜ is as follows:
$${P}_{int} = - J ω \frac{d ω}{dt}$$
wherein J is a moment of inertia of a rotor, and ω is the mechanical angular velocity;
keeping, in a case of no change on the mechanical angular velocity, the virtual inertia active power instruction Pᵢₙₜ unchanged;
re-calculating and updating, in a case of the current mechanical angular velocity deviating from the mechanical angular velocity reference value, the primary frequency regulation control characteristic P_{droop}, wherein the formula for calculating P_{droop} is as follows:
$${P}_{droop} = - \frac{1}{m} ( ω - {ω}_{ref} )$$
wherein ω_{ref} is the mechanical angular velocity reference value, and m is a droop coefficient;
outputting and issuing, by a virtual governor, an active power instruction P_{ref} to the active power-frequency module, wherein the formula for calculating P_{ref} is as follows:
$${P}_{ref} = {P}_{int} + {P}_{droop}$$
issuing the active power instruction P_{ref} to the active power-frequency module, and regulating a grid-connected current by means of current closed-loop feedback control;
controlling, by a virtual exciter, a reactive power voltage characteristic of the synchronous generator, wherein an output reactive power instruction Q_{ref} of a virtual synchronous charging and discharging machine is:
$${Q}_{ref} = {K}_{V} {S}_{N} ( U - {U}_{ref} ) / {U}_{N}$$
wherein K_{V} is a reactive power voltage regulation coefficient, S_{N} is a rated apparent power, U is a grid-side voltage, U_{ref} is a reference voltage, and U_{N} is a rated voltage;
detecting whether there are external factors, wherein
external influence detection comprises load sudden change detection and power grid frequency deviation detection, and
load sudden change detection comprises:
periodically acquiring a sampled load power value P_{load}(k), and calculating a load power change amount ΔP_{load}(k), wherein the formula for calculating ΔP_{load}(k) is as follows:
$$Δ {P}_{load} ( k ) = Δ {P}_{load} ( k - 1 ) + {dP}_{load} ( k ) / dt * T$$
wherein k is a sampling sequence number, and T is a sampling period;
considering occurrence of a load sudden change in a case of the load power change amount ∥ |ΔP_{load}(k)| being larger than a load sudden change criterion threshold P_{Id};
monitoring a power grid frequency f_{grid} in real time, and calculating a frequency deviation Δf_{gr}id, wherein the formula for calculating Δf_{grid} is as follows:
$$Δ {f}_{grid} = {f}_{grid} - {f}_{ref}$$
wherein f_{ref} is a power grid rated frequency reference value;
considering there is the power grid frequency deviation in a case of |Δf_{grid}| being larger than a frequency deviation criterion threshold f_{gd};
compensating, if so, the active power instruction P_{ref} correspondingly, and keeping the grid-connected current at a preset value, wherein
compensation components comprise a load sudden change compensation component and a power grid frequency deviation compensation component;
the formula for calculating the load sudden change compensation component ΔP_{load_comp} is as follows:
$$Δ {P}_{load \_ comp} = - Δ {P}_{load} ( k )$$
and the formula for calculating the power grid frequency deviation compensation component ΔP_{fgrid_comp} is as follows:
$$Δ {P}_{fgrid \_ comp} = {k}_{f} * Δ {f}_{grid}$$
wherein k_{f} is a frequency-active power control coefficient;
re-calculating the active power instruction according to the compensation components, and acquiring a final active power instruction P_{ref_new}, wherein the calculation formula is as follows:
$${P}_{ref \_ new} = {P}_{ref} + Δ {P}_{fgrid \_ comp} + Δ {P}_{load \_ comp}$$
issuing, by a coordinated control module, an operation parameter by using parallel bus communication, and dynamically regulating operation states of the active power-frequency module and the reactive power-voltage module; and
regulating a reactive power of the bidirectional AC/DC unit and charging and discharging power limits of the DC/DC module, allowing for a function of the virtual synchronous charging and discharging machine participating in frequency and voltage regulation functions of the power grid.

7. The charging and discharging control method for the electric vehicle based on virtual synchronization according to claim 6, wherein the measuring and settling comprises:
accurately measuring an energy flow in charging and discharging via a bidirectional measuring unit, and providing a user with precise billing and settlement information; and
the authentication comprises:
performing, by the user, charging authentication via card swipe, two-dimensional code scanning, or password input, and viewing relevant data in charging and discharging, wherein
the relevant data comprises the energy flow, a power level and a charging duration.

8. A system using the charging and discharging control method for the electric vehicle based on virtual synchronization according to claim 7, comprising an AC grid-connected interface unit, a bidirectional AC/DC unit, a bidirectional DC/DC unit, a switch control unit, a bidirectional measuring unit, a central control unit, a charging interface unit and a virtual synchronization control unit, wherein
the AC grid-connected interface unit is configured to connect a virtual synchronous charging and discharging machine with a power grid in starting, and disconnect the virtual synchronous charging and discharging machine with the power grid in a case of a fault;
the bidirectional AC/DC unit is configured to convert filtered electric energy on an AC grid side to DC, and convert the DC electric energy from the electric vehicle to AC for being fed back to the power grid, and is connected to the virtual synchronization control unit for regulating an active/reactive power operation state according to an instruction from the central control unit;
the bidirectional DC/DC unit is configured to achieve power conversion with a DC port on the electric vehicle side;
the switch control unit is configured to control a DC connection state with the battery of the electric vehicle;
the bidirectional measuring unit is configured to provide a human-computer interaction interface and record various data in charging and discharging;
the central control unit is configured to process frequency and voltage regulation instructions from the power grid, receive the battery state information of the vehicle, and coordinate operations of various units to overall control virtual synchronous charging and discharging;
the charging interface unit is configured to connect the virtual synchronous charging and discharging machine with the electric vehicle in charging and discharging; and
the virtual synchronization control unit is configured to dynamically regulate charging operation parameters according to a higher-level instruction, simulate electromechanical transient characteristics, construct virtual inertia and primary frequency regulation power instructions, and regulate a grid-connected current by means of a current closed loop.

9. A computer device, comprising a memory in which a computer program is stored and a processor, wherein the processor, when executing the computer program, implements the steps of the charging and discharging control method for the electric vehicle based on virtual synchronization according to claim 7.

10. A computer-readable storage medium in which a computer program is stored, wherein when the computer program is executed by a processor, the steps of the charging and discharging control method for the electric vehicle based on virtual synchronization according to claim 7 are implemented.
